(19) United States
(12) Patent Application Publication
(10) Pub. No.: US 2010/0109824 A1
(43) Pub. Date: May 6, 2010

(54) UNITARY MULTI-CELL CONCENTRIC CYLINDRICAL BOX GIRDER COLDMASS APPARATUS FOR OPEN AIR MRI TO AVOID SUPERCONDUCTING MAGNET QUENCH

(75) Inventor: SOU TIEN WANG, Danville, CA (US)

Correspondence Address: PATENTRY, P.O. BOX 151616, SAN RAFAEL, CA, 94915-1616, US

(73) Assignee: WANG NMR INC, Livermore, CA (US)

(21) Appl. No.: 12/266,164

(22) Filed: Nov. 6, 2008

(51) Int. Cl. H01F 6/00

(52) U.S. Cl. 335/216

(57) ABSTRACT

An apparatus for open air MRI magnet support comprises a high modulus co-planar multi-cell concentric cylindrical box girder for to support superconductive coil elements with high rigidity. A single unitary coldmass comprises at least three vertical bearing members coupled to an upper multi-cell concentric cylindrical box beam and to a lower multi-cell concentric cylindrical box beam which supports superconductive coil elements against 50-100 ton electromagnetic forces in axial and radial (hoop) directions with trace deformation whereby frictional heating is prevented for to avoid magnet quench.

A co-pending related patent application Ser. No. 12/257,399 was filed Oct. 24, 2008 by the same inventor SOU TIEN WANG and assignment was recorded on reel 021736 frame 0769 to a common assignee WANG NMR INC.

### BACKGROUND

(MRI) is primarily a medical imaging technique most commonly used in Radiology to visualize the structure and function of the body. It provides detailed images of the body in any plane. MRI provides much greater contrast between the different soft tissues of the body than does computed tomography (CT), making it especially useful in neurological (brain), musculoskeletal, cardiovascular, and oncological (cancer) imaging. Unlike CT, it uses no ionizing radiation, but uses a powerful magnetic field to align the nuclear magnetization of (usually) hydrogen atoms in water in the body. Radiofrequency fields are used to systematically alter the alignment of this magnetization, causing the hydrogen nuclei to produce a rotating magnetic field detectable by the scanner. When a person lies in a scanner, the hydrogen nuclei (i.e., protons) found in abundance in the human body in water molecules, align with the strong main magnetic field. A second electromagnetic field, which oscillates at radiofrequencies and is perpendicular to the main field, is then pulsed to push a proportion of the protons out of alignment with the main field. These protons then drift back into alignment with the main field, emitting a detectable radiofrequency signal as they do so.

Magnet quench is referred to simply as quench.

A quench occurs when part of the superconducting coil transforms into the normal resistive state. This is because either the field inside the magnet exceeds critical field strength, the rate of change of field is too great causing eddy current heating in the copper support matrix, or the conductor temperature exceeds its critical temperature due to frictional heating or epoxy cracking. When quench happens, that particular non-superconduction spot is subject to rapid joule heating, which raises the temperature of the surrounding regions. This heat further spreads the normal state propagation which leads to more heating. The entire magnet rapidly within seconds becomes normal and consumes the entire stored energy of the magnet. This is accompanied by percussive rapid boil-off of the cryogen. Permanent damage to the magnet can occur if the magnet is not properly protected. Economically, a quench requires a magnet to be recooled, reenergized and reshimmed to achieve a stable and homogenous field suitable for imaging. Recooling, reenergizing, and reshimming a magnet results in weeks of non-production. These effects require on-site services by field engineers for weeks to reshim to a stable homogenous field. Cryogen, its delivery, and field service are very costly.

Magnetic field strength is an important factor in determining image resolution and speed. Higher magnetic fields increase signal-to-noise ratio, permitting higher resolution or faster scanning. However, higher field strengths require more costly magnets with higher fringing field, and have increased patient safety concerns. Nowaday, one Tesla through three Tesla field strengths are a good compromise between cost and performance and are FDA approved for general clinical use. However, for certain specialist medical research uses (e.g., brain functional imaging), field strengths of 4.0 Tesla and higher will be needed.

The lack of harmful effects on the patient and the operator make MRI well-suited for “interventional radiology”, where the images produced by a MRI scanner are used to guide minimally-invasive procedures. Of course, such procedures must be done to avoid ferromagnetic instruments.

In the US, the 2007 Deficit Reduction Act (DRA) significantly reduced reimbursement rates paid by federal insurance programs for the technical component of many scans, shifting the economic landscape. Many private insurers have followed suit.

Currently, in the US, there is increasing interest in reducing the costs associated with MRI services and simultaneously improving the ability to effectively and efficiently provide MRI examination services to larger numbers of patients with improved efficiency in equipment and space utilization.

While the additional capabilities of MRI technology make them increasingly attractive, there are drawbacks discouraging and inhibiting wide-spread adoption. These include noise, size, tightness, and tradeoffs with scan quality. Better image contrast and speed of results is a benefit of adopting newer technology with stronger fields.

Due to the construction of some MRI scanners, they can be potentially unpleasant to lie in. Older models of closed bore MRI systems feature a fairly long tube or tunnel. The part of the body being imaged needs to lie at the center of the magnet which is at the absolute centre of the tunnel. Because scan times on these conventional MRI machines may be long (occasionally up to 40 minutes for the entire procedure), people with even mild claustrophobia are sometimes unable to tolerate an MRI scan without some comfort management.

For babies and young children chemical sedation or general anesthesia are the norm, as these subjects cannot be instructed to hold still during the scanning session. Pregnant women may also have difficulty lying on their backs for an hour or more without moving. Acoustic noise associated with the operation of an MRI scanner can also exacerbate the discomfort associated with the procedure. Thus it can be appreciated that there exists a need for improved designs for the support structure of superconducting open air MRI magnets while providing higher strength uniform fields needed for rapid imaging.

A cylinder is herein defined as a ruled surface spanned by a one-parameter family of parallel lines. Commonly, cylinders are thought of as right circular cylinders but generally may be elliptical cylinders, parabolic cylinders, hyperbolic cylinders or polygonal cylinders. A hexagonal or octagonal tube illustrates the concept without limitation of a polygonal cylinder.

### SUMMARY OF THE INVENTION

The present invention comprises a single rigid high moment of inertia multiple connected box of high modulus metal structure to support 50-100 tons of electromagnetic force between the upper and lower magnet elements within the coldmass without substantial deformation. The multiple connected box comprises a plurality of concentric cylinders coupled to flange plates forming closed multi-layer multi-cell concentric cylindrical box girders coupled to at least three vertical compression members to support against 50-100 ton force between the upper and lower superconductive coil elements. The cylinders support each coil element in the radial (hoop) plane.

### BRIEF DESCRIPTION OF DRAWINGS

The drawings are illustrative of embodiments and not represented as limitations of the scope of the invention.

FIG. 1 is conventional box girder.

FIG. 2 is a cylindrical box girder in perspective.

FIG. 3 shows a sectioned multi-cellular cylindrical box girder.

FIG. 4 shows a sectioned perspective of a multi-layer multi-cellular concentric cylindrical box girder.

FIG. 5 is a cutaway perspective view of an mri magnet coldmass.

### FIGURE REFERENCES

100 A conventional box girder

110 Flange

120 Web

200 Closed cylindrical box girder

210 Planar flange

220 Cylindrical webs

300 Co-planar multi-cell concentric cylindrical box girder

310 Inner box girder planar flange

320 Concentric cylindrical webs

330 Outer box girder planar flange

400 Quench avoidance apparatus for open air mri magnet

430 Shield co-planar concentric multi-cell box girder

431 Shield outer box girder flange

432 Shield concentric cylindrical web

433 Shield inner box girder flange

440 Primary coil co-planar concentric multi-cell box girder

441 Primary coil outer box girder planar flange

442 Primary coil concentric cylindrical web

443 Primary coil inner box girder planar flange

450 Vertical compression member

In an embodiment a flange is a polygonal or circular annulus. In an embodiment a single plate couples to plurality of concentric cylinders and forms a planar flange for a multi-cell box girder.

### DETAILED DISCLOSURE OF EMBODIMENTS

It is the observation of the inventor that conventional high field superconducting magnets “quench” losing their magnetic field due to conductor heating because of conductor frictional motion or epoxy cracking. Excessive deformation of the coil support structure causes friction or epoxy cracking which in turn heats a portion of the coil above the superconducting temperature. The present invention provides high rigidity high modulus structural support in both the axial and radial (hoop) directions to the superconducting elements of the primary and shielding coils whereby high field MRI magnets can be consistently and reliably sustained without excessive deformation and the resulting heating, rise in temperature, loss of superconductivity, and in short quench. It is the objective of the present invention to provide efficient structural support and sustain high 12^{th} order uniform fields in mri magnets by substantially reducing stress and coil deformation to avoid quench.

A superconducting magnet apparatus for MRI, of the present invention has a coldmass, which contains a rigid metal structure having load bearing strength of range 50-100 tons. This structure is capable of supporting electromagnetic force with trace deformation. Superconducting magnets include a superconducting coil group formed of plural superconducting coil elements. Trace deformation is within the range that precedes conductor slippage. In an embodiment, a coil element is embedded in a wax or epoxy matrix. In an embodiment, trace deformation is within the range of stress below matrix cracking stress or within the elastic stress limit of supporting elements or within the frictional motion of conductor slippage.

The coldmass includes a helium vessel for accommodating the superconducting coil groups and the rigid metal structure, and has a portion for connecting the helium vessel to the rigid metal structure. The coldmass includes magnet elements, the structure support, and the helium vessel which maintains the coldmass at 4K. The coldmass is pivotally coupled to a plurality of coldmass suspenders coupled to a vacuum vessel for accommodating the coldmass and providing vacuum insulation by maintaining an interior under vacuum. The pivotal coupling allows contraction and expansion of the coldmass without thermally induced stress in the helium vessel or elements of the coldmass suspension system.

The coldmass suspenders are further coupled to a heat shield that is provided in a space between the helium vessel and the vacuum vessel to block off radiation heat to the helium vessel from the vacuum vessel. In an embodiment, the heat shield is thermally coupled to a 60-77K heat sink attached to a 77K coldhead first stage. This design arrangement greatly minimizes the heat leak between the 300K and 4.2K vessels.

It is particularly disclosed that the electromagnetic force between the superconducting magnet elements is supported only by the rigid metal structure within the coldmass and only the gravitational force of the coldmass is supported in tension by the coldmass suspenders between the helium vessel and the vacuum vessel. It is particularly disclosed that significant forces acting on the coldmass suspenders result from decelerations or accelerations of the vacuum vessel during transportation and gravity operating on the coldmass but that electromagnetic force between the coldmass and the non-magnetic vacuum vessel is negligible and the helium vessel may be dimensioned only to sustain the pressure of cryogen against a vacuum or magnet quench.

In an embodiment of the superconducting magnet apparatus for MRI, an antivibration bellows is coupled to a vacuum sleeve removeably coupled to a cryogen coldhead, whereby access to and maintenance of the coldhead is enabled without loss of cryogen or warming the magnet. This also allows transport of the magnet without a coldhead. A coldhead being a mechanical part, it is desireable to allow it to be removed, maintained, serviced, upgraded, or replaced without warming the magnet.

A superconducting magnet apparatus for MRI, is disclosed comprising: a coldmass, the coldmass comprising a rigid metal structure having load bearing strength of range 50-100 tons, supporting electro-magnetic force with trace deformation, a plurality of superconducting coil elements, the coldmass further comprising
a helium vessel for accommodating the superconducting coil groups and the rigid metal structure, and
a portion for connecting the helium vessel to the rigid metal structure, the coldmass pivotally coupled to
a plurality of coldmass suspenders coupled to
a vacuum vessel for accommodating the coldmass and providing vacuum insulation by maintaining an interior under vacuum, and the coldmass suspenders further coupled to a heat shield that is provided in a space between the helium vessel and the vacuum vessel to block off radiation heat to the helium vessel from the vacuum vessel; wherein, the electro-magnetic force load between the superconducting magnet elements bears on only the rigid metal structure within the coldmass and not on the vacuum vessel and only the gravitational force of the coldmass is supported in tension by the coldmass suspenders which couple the helium vessel to the vacuum vessel.

The magnet apparatus for MRI disclosed in the present patent application is distinguished from prior art by its rigid metal structure made of a plurality of cylinders for to support each superconducting coil against forces in a radial (hoop) direction and in an axial direction.

In an embodiment the superconducting magnet apparatus for MRI has a coldmass suspender for pivotally coupling a vacuum vessel interior side to a heatshield and further pivotally coupling to a coldmass to achieve a structure for to prevent induced stress due to thermal contraction during coldmass cooling.

In an embodiment the superconducting magnet apparatus for MRI has a connection member for connecting the pair of the gradient coils; a beam structure member for connecting the connection member to the vacuum vessel; and a_vibration damping buffer interposed between the beam structure member and the vacuum vessel.

A superconducting magnet apparatus for MRI, is disclosed comprising:
a coldmass, the coldmass comprising a rigid metal structure having load bearing strength of range 50-100 tons, supporting electromagnetic force with trace deformation,
a top superconducting magnet element and
a bottom superconducting magnet element spaced apart from each other with the top superconducting magnet element being on top of the bottom superconducting magnet, each of the top and bottom superconducting magnets elements including a superconducting coil group formed of plural superconducting coils, the rigid metal structure having at least three pillars,
the coldmass further comprising
a helium vessel for accommodating the superconducting coil groups and the rigid metal structure, and
a portion for connecting the helium vessel to the rigid metal structure, the coldmass pivotally coupled to
a plurality of coldmass suspenders coupled to
a vacuum vessel for accommodating the coldmass and providing vacuum insulation by maintaining an interior under vacuum, and the coldmass suspenders further coupled to a heat shield that is provided in a space between the helium vessel and the vacuum vessel to block off radiation heat to the helium vessel from the vacuum vessel;
the vacuum vessel, the heat shield, and the helium vessel each further comprising at least one access port between two pillars of the rigid metal structure, allowing the installation of a pair of gradient coils juxtaposed to opposing inner surfaces between the top superconducting magnet element and the bottom superconducting magnet element to generate a gradient magnetic field, wherein: a homogeneous magnetic field and a gradient magnetic field are generated in a space between the top superconducting magnet element and the bottom superconducting magnet element; wherein, the electro-magnetic force between the superconducting magnet elements is substantially supported only by the rigid metal structure within the coldmass and only the gravitational force of the coldmass is substantially supported in tension by the coldmass suspenders and the vacuum vessel.

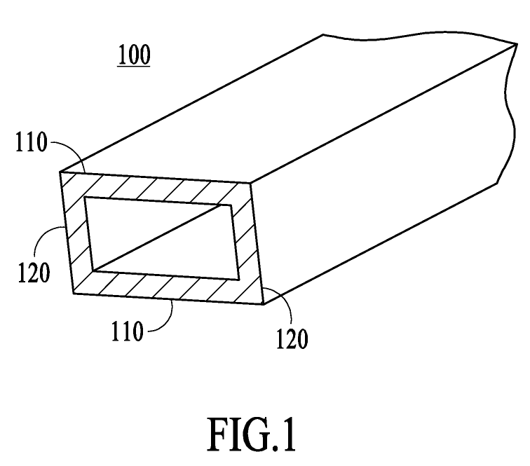

A box girder is known as a high moment of inertial structural element in structural mechanics and in architecture. Referring now to FIG. 1, a conventional box girder comprises a top and bottom flange 110 and webs 120 as side members. The cross section of box girders may be square, rectangular, or trapezoidal. In elevated highway construction, box girders are used for curving roadways and ramps. A box girder with multiple web members may be described as a multi-cell box girder and analyzed as a plurality of associated I-beams in torsion, tension, and compression.

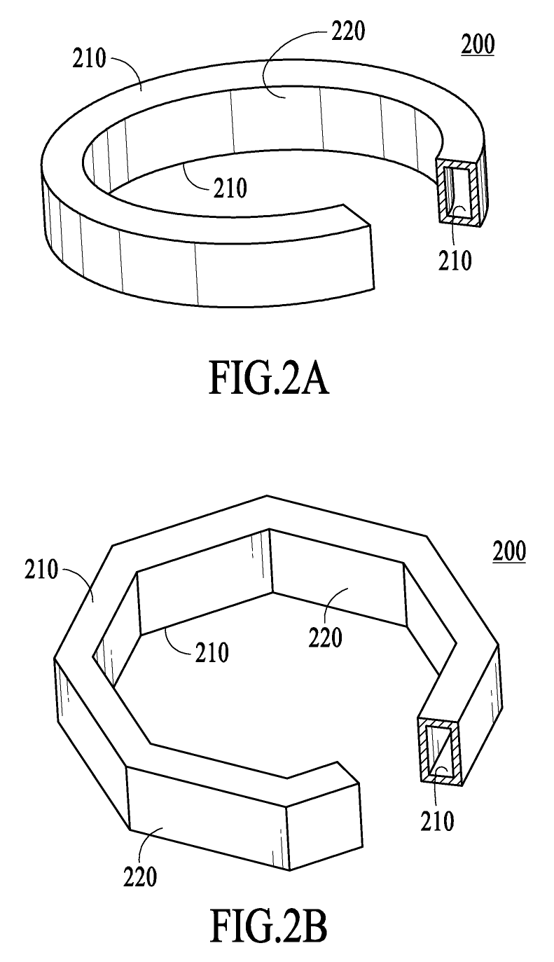

In cross-section, a pair of parallel plates coupled by a pair of concentric cylinders resembles the same square or rectangular form as a box girder. FIGS. 2A and 2B illustrates a concentric cylinder box girder of the present invention. The concentric cylinder box girder 200 comprises an inner plate flange and an outer plate flange 210 in parallel coupled rigidly by welding to an inner cylindrical web 220 and an outer cylindrical web 230.

While cylinders are commonly understood to have circular cross-section, the present invention defines a cylinder as a ruled surface spanned by a one-parameter family of parallel lines. Thus within the present patent application, a cylinder also means a polygonal cylinder not limited to but as an example having an octagonal or hexagonal cross-section without departing from the disclosed invention. FIG. 2B illustrates the invention embodied with polygonal cylinders for webs.

The present invention discloses a co-planar multi-cell concentric cylindrical box girder comprising a plurality of concentric cylinders disposed vertically sandwiched between plates disposed horizontally by welding to form a rigid metal structure. Each cell performs as a closed cylindrical box girder. In the present invention the box girder supports torsional loading between adjacent coil elements and electromagnetic loading of 50-100 tons between the upper magnet elements and the lower magnet elements. The present invention provides a multi-layer multi-cell concentric cylindrical box girder to rigidly support a plurality of primary coil elements and a plurality of shield coil elements within a coldmass which further comprises a single helium vessel.

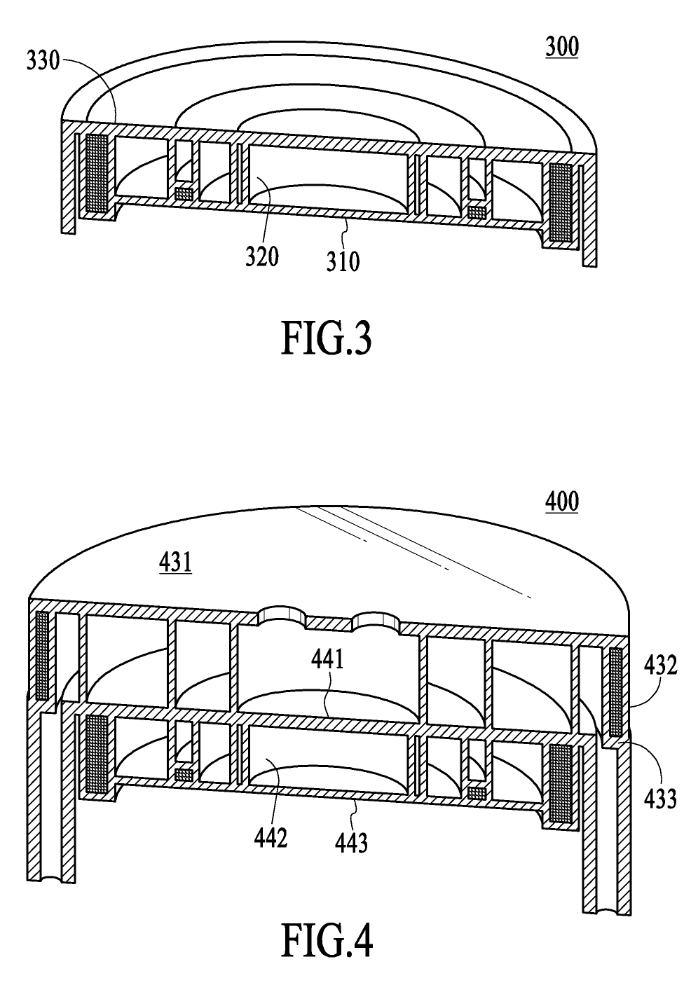

FIG. 3 illustrates a multi-cell concentric cylinder box girder. A plurality of concentric cylinders 320 provide compartmentalization, and are each coupled to an inner flange plate 310 and to an outer flange plate 330. It is known that box girders comprised of webs and flanges provide a much higher moment of inertia structure than simple open flange structure in the construction of bridges and buildings against gravitational and seismic forces. By rigid metal structure we mean a metal structure that does not fail or plastically deform under a load of 50-100 tons.

FIG. 4 illustrates a cut away multi-layer multi-cell concentric cylindrical box girder. A primary coil box girder is coupled to a shield box girder. The shield co-planar concentric multi-cell box girder 430 is disclosed to comprise a shield outer box girder flange plate 431 coupled to a plurality of shield concentric cylindrical webs 432 coupled to a shield inner box girder flange 433.

The primary coil co-planar concentric multi-cell box girder 440 is disclosed to include a primary coil outer box girder flange plate 441 said flange plate coupled to a plurality of primary coil concentric cylindrical webs 442, said walls coupled to a primary coil inner box girder flange plate 443. The cylinders are disposed concentrically and vertically. The flange plates are disposed above and below the cylinders, horizontally.

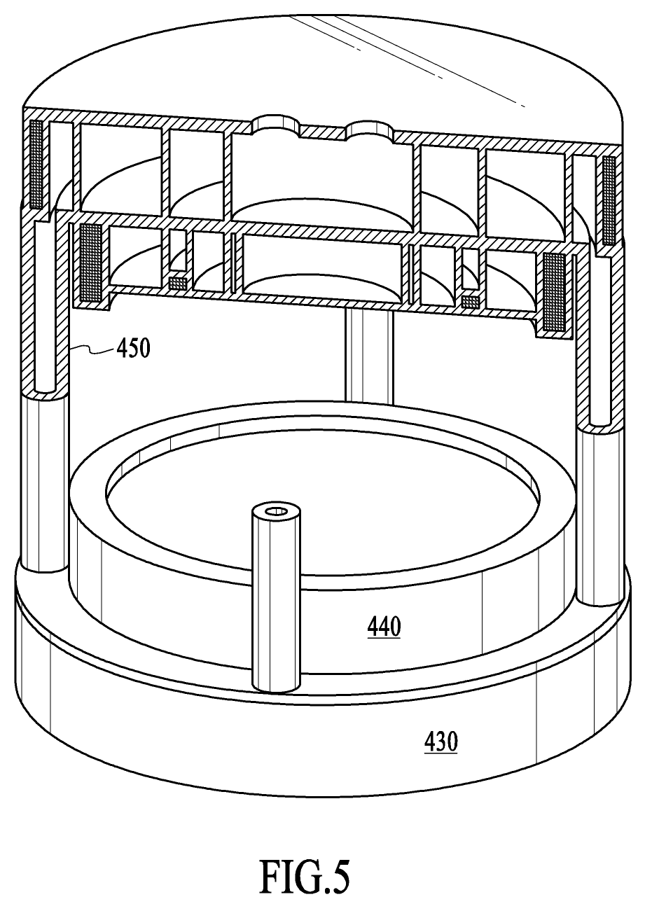

FIG. 5 illustrates an open air mri magnet coldmass comprising two multi-layer multi-cell concentric cylindrical box girders coupled by at least three and preferably four vertical compression members which also serves as the helium vessel suspended within a vacuum vessel. A heatshield is provided exterior to the helium vessel and interior to the vacuum vessel. Access to the region of imaging between the upper and lower magnet elements is provided by ports through the heatshield and the vacuum vessel between the vertical

An embodiment of the present invention is an apparatus for open air mri magnet comprising a vacuum vessel, coupled to a plurality of coldmass suspenders, the suspenders coupled to a coldmass, the coldmass suspenders also coupled to a heatshield in the space interior of the vacuum vessel and exterior of the coldmass, the coldmass comprising a helium vessel, a plurality of superconducting electromagnet coil elements, an upper primary coil co-planar concentric multi-cell box girder, said box girder coupled to at least three vertical compression members, and said compression members coupled to a lower primary coil co-planar concentric multi-cell box girder for to support superconducting electromagnet coil elements.

An upper shield co-planar concentric multi-cell box girder and a lower shield co-planar concentric multi-cell box girder are disclosed wherein said upper shield box girder is above the upper primary coil box girder and said lower shield box girder is below the lower primary coil box girder and the two shield box girders defines a vessel for to contain helium. The outer cylinder of the smaller box girder couples to the larger box girder to enclose the volume within which the cryogen, in an embodiment liquid helium, is contained.

A cylindrical box girder contains at least a superconducting electromagnetic coil element. In an embodiment a cylindrical box girder further contains a wax or epoxy matrix.

The vertical compression member is a column or a pillar which supports the load of the electromagnetic force between the upper and lower magnet elements.

In an embodiment there are at least three upper primary superconducting coil elements and three lower primary superconducting coil elements. There are only one upper field shielding superconducting coil and one lower field shielding superconducting coil. These shielding coils are designed to achieve zero magnetic moment while obtaining a highly homogenous MRI field.

A best mode embodiment of the invention is a coldmass apparatus for a quench avoidant mri magnet comprising at least three vertical compression members coupled to a top primary base plate and a bottom primary base plate, wherein each primary base plate couples at least four concentric cylinders to a top primary outer plate and a bottom primary outer plate whereby at least six endless cylindrical box beams provide a high moment of inertia structure for to enclose at least six primary superconducting coil elements and epoxy filler wherein said plates and cylinders are dimensioned to prevent cracking of the epoxy due to electromagnetic force. In an embodiment there are 8 superconducting coil elements.

The cold mass suspenders comprise a plurality of axial direction supporting members for supporting the coldmass against a force in an axial direction, and a plurality of radius direction supporting members for supporting the coldmass against forces in a radius direction and in an azimuthal direction.

The superconducting magnet apparatus also has an anti-vibration bellows coupled to a vacuum sleeve removeably coupled to a cryogen coldhead, whereby access to and maintenance of the coldhead is enabled without loss of cryogen or warming the magnet.

The box girders comprises a plurality of cylinders for to support each superconducting coil against forces in a radius direction and in an azimuthal direction.

In an embodiment, box girders comprise a plurality of plates rigidly attached to a plurality of cylinders containing superconducting coil elements forming cross-sectional boxes to achieve a high moment of inertia structure with trace deformation due to axial electromagnetic forces, wherein the plates and cylinders are formed from 300 series non-magnetic stainless steel.

A superconducting magnet apparatus for MRI is disclosed comprising a rigid metal structure supporting with trace deformation, a top superconducting magnet element and a bottom superconducting magnet element, coupled by four vertical compression members and a vacuum vessel, a heat shield, and a helium vessel each further comprising an access port between adjacent compression members. By trace deformation we mean not that there is no deformation but that it is very limited, ie wherein trace deformation is determined to cause less than conductor slippage or epoxy cracking stress so that the superconducting coils cannot move and generate heat from friction or receive energy released by the cracking of epoxy.

The best mode of the superconducting magnet apparatus for MRI provides the coldmass with four vertical compression members coupling a top superconducting magnet element and a bottom superconducting magnet element, and serving as a support against electromagnetic forces acting between the top superconducting magnet element and the bottom superconducting magnet element whereby quenching of the magnet is less likely due to trace deformation of the magnet.

An embodiment of the superconducting magnet apparatus for MRI has a connection member for connecting the pair of the gradient coils; a beam structure member for connecting the connection member to the vacuum vessel; and a vibration damping buffer interposed between the beam structure member and the vacuum vessel.

An embodiment of the superconducting magnet apparatus for MRI has a connection member for connecting the pair of the gradient coils; at least three pillars attached to a base of the bottom superconducting magnet element; and a beam-shaped member for connection member and each pillar.

In an embodiment the cold head assembly comprises a Gifford-McMahon refrigerator cryocooler coupled to an anti-vibration bellows, and a plurality of springs which dampen the moment inertia of movement of the coldhead.

In an embodiment the plurality of suspenders comprise radial tension members attached to said superconducting magnet allowing radial contraction of the superconducting magnet as it is cooled without thermal stress whereby the angle between the tension member and the superconducting magnet changes at a pivot pin coupling said tension member to the superconducting magnet as the temperature of the superconducting magnet changes and the diameter of the superconducting magnet expands or contracts.

In an embodiment the plurality of suspenders comprise eight radial tension members having pivotal fasteners at each end.

In an embodiment the plurality of suspenders comprise axial tension members attached to said superconducting magnet allowing axial contraction of the superconducting magnet as it is cooled without thermal stress wherein one end of each axial suspender is attached to the midpoint of the superconducting magnet at a pivot pin coupling said tension member to the superconducting magnet allowing the length of the superconducting magnet to expand or contract as the temperature of the coldmass changes.

In an embodiment of the superconducting magnet apparatus for MRI the invention includes a coldmass suspender for pivotally coupling a vacuum vessel interior side to a heatshield and further pivotally coupling to a coldmass to achieve a structure that prevents thermal stress due to contraction during cryogen cooling of the coldmass. By properly sizing the inclined angle and by positioning a pivotal coupling, the contraction of the suspender and the contraction of the coldmass in substantially perpendicular directions during cooling can be equalized without changing the strain on the suspender.

In an embodiment of the present invention, the superconducting magnet apparatus for MRI further comprises a flexible bellows for transmitting gas from the helium vessel and for returning recondensed liquefied helium to the vessel.

### CONCLUSION

The present invention is distinguished from prior art conventional MRI magnets by a coldmass comprising a unitary rigid metal structure to support a compressive load of 50-100 tons due to electro-magnetic force between the elements of a superconducting magnet. The beneficial advantage over prior art of this distinguishing structure allows the vacuum vessel to be much thinner and lighter except where the coldmass is supported against gravitational force or accelerations during transport and installation. By limiting deformation of the superconducting coils, the frequency, inconvenience, and expense of recovering from magnet quench is minimized. The mass and expense of the vacuum vessel may also be reduced as it does not bear the load of higher electromagnetic force enabled by this structure not appreciated in prior art. Finally, the image quality and length of time may be optimized by enabling a much stronger and larger homogenous magnetic field than conventional mri.

Embodiments of the present invention allow higher magnetic field strengths for higher quality imaging, quicker scans, less claustrophobia, improved interaction between patient and provider, and larger volumes or larger patients to be imaged than conventional mri magnets. The electromagnetic force does not bear on the vacuum vessel.

Prior art box girders have not been disclosed to comprise cylinders of non-magnetic stainless steel to bear radial and azimuthal electro-magnetic loads from superconducting coils. It is particularly pointed out that prior art MRI magnets are not disclosed to withstand 50 or more tons of electromagnetic force between coil elements without deformation which is the reason they suffer quench at high field strengths. It is particularly pointed out that prior art superconductive open air magnets have a plurality of coldmasses in contrast to the unitary coldmass of the present invention.

While cylinders are commonly understood to have circular cross-section, the present invention defines a cylinder as a ruled surface spanned by a one-parameter family of parallel lines. Thus a cylinder also means a polygonal cylinder for example having an octagonal or hexagonal cross-section without departing from the disclosed invention.

Significantly, this invention can be embodied in other specific forms without departing from the spirit or essential attributes thereof, and accordingly, reference should be had to the following claims, rather than to the foregoing specification, as indicating the scope of the invention.

What is claimed is:

1. An apparatus for open air mri magnet comprising a vacuum vessel, coupled to a plurality of coldmass suspenders, the suspenders coupled to a coldmass, the coldmass suspenders also coupled to a heatshield in the space interior of the vacuum vessel and exterior of the coldmass, the coldmass comprising a helium vessel, the helium vessel comprising a plurality of superconducting electromagnet coils, the superconducting electromagnet coils enclosed within a first primary coil co-planar multi-cell concentric cylindrical box girder, said box girder coupled to at least three vertical compression members, and said compression members coupled to a lower primary coil co-planar multi-cell concentric cylindrical box girder for to support and enclose a second primary superconducting electromagnet coil element.

2. The apparatus of claim 1 wherein the primary coil co-planar multi-cell concentric cylindrical box girder comprises a primary coil outer box girder flange plate said flange plate coupled to a plurality of primary coil concentric cylindrical webs, said webs coupled to a primary coil inner box girder flange plate.

3. The apparatus of claim 1 further comprising an upper shield co-planar multi-cell concentric cylindrical box girder and a lower shield co-planar multi-cell concentric cylindrical box girder where in said upper shield box girder is above the upper primary coil box girder and said lower shield box girder is below the lower primary coil box girder and the two shield box girders defines a vessel for to contain helium.

4. The apparatus of claim 3 wherein the shield co-planar multi-cell concentric cylindrical box girder comprises a shield outer box girder flange plate coupled to a plurality of shield concentric cylindrical webs, the webs coupled to a shield inner box girder flange plate.

5. The apparatus of claim 4 wherein each box girder contains at least a superconducting electromagnetic coil element.

6. The apparatus of claim 5 wherein each box girder further contains epoxy.

7. The apparatus of claim 5 wherein each box girder further contains wax.

8. The apparatus of claim 1 wherein the vertical compression member is a pillar.

9. The apparatus of claim 1 wherein the vertical compression member is a column.

10. The apparatus of claim 1 wherein the plurality of superconducting electromagnet coils comprise three upper primary superconducting coil elements and three lower primary superconducting coil elements.

11. The apparatus of claim 3 further comprising at least one upper field shielding superconducting coil element and at least one lower field shielding superconducting coil element.

12. The superconducting magnet apparatus for MRI according to claim 11, wherein:
the cold mass suspenders comprise axial direction supporting members for supporting the coldmass against a force in an axial direction, and radius direction supporting members for supporting the coldmass against forces in a radius direction and in an azimuthal direction.

13. The superconducting magnet apparatus for MRI according to claim 11, further comprising gradient coils wherein: concave portions are provided in the opposing inner surfaces of the vacuum vessel, and the gradient coils are disposed in the concave portions.

14. The superconducting magnet apparatus for MRI according to claim 11, further comprising: an anti-vibration bellows coupled to a vacuum sleeve removeably coupled to a cryogen coldhead, whereby access to and maintenance of the coldhead is enabled without substantial loss of cryogen or warming the magnet.

15. The superconducting magnet apparatus for MRI according to claim 11, wherein: the multi-cell concentric cylindrical box girders comprises a plurality of cylinders for supporting each superconducting coil against forces in a radius direction and in an azimuthal direction.

16. The superconducting magnet apparatus for MRI according to claim 11, wherein the multi-cell concentric cylindrical box girders further comprise a plurality of plates rigidly attached to a plurality of cylinders containing superconducting coils forming cross-sectional boxes to achieve a high moment of inertia structure for to prevent deformation due to axial electro-magnetic forces, wherein the plates and cylinders are formed from 300 series non-magnetic stainless steel.

17. The superconducting magnet apparatus for MRI according to claim 11, further comprising: a coldmass suspender for pivotally coupling a vacuum vessel interior side to a heatshield and further pivotally coupling to a coldmass to achieve a structure for to prevent thermal stress due to contraction during cryogen cooling of the coldmass.

18. A coldmass apparatus for a quench avoidant mri magnet comprising at least three vertical compression members coupled to a top primary base plate and a bottom primary base plate, wherein each primary base plate couples at least four concentric cylinders to a top primary outer plate and a bottom primary outer plate whereby at least six endless cylindrical box beams provide a high moment of inertia structure for to enclose at least six primary superconducting coil elements and epoxy filler wherein said plates and cylinders are dimensioned to prevent cracking of the epoxy due to electromagnetic force.

19. A superconductor enabled magnet apparatus for MRI comprising a rigid metal structure supporting with trace deformation, wherein trace deformation is determined as force within the range of superconductor non-slippage, a top superconductor magnet element and a bottom superconductor magnet element, coupled by vertical compression members and a vacuum vessel, a heat shield, and a helium vessel each further comprising an access port between adjacent compression members.

20. The magnet apparatus for MRI according to claim 19, wherein: the coldmass comprises four vertical compression members coupling a top superconductor magnet element and a bottom superconductor magnet element, and serving as a support against electromagnetic forces acting between the top superconductor magnet element and the bottom superconductor magnet element whereby quenching of the magnet is less likely due to trace deformation of the magnet.

21. The magnet apparatus for MRI according to claim 19, further comprising: a flexible bellows for transmitting gas from the helium vessel and for returning condensed liquefied helium to the helium vessel.

22. The magnet apparatus for MRI according to claim 19 further comprising: a connection member for connecting the pair of the gradient coils; a beam structure member for connecting the connection member to the vacuum vessel; a vibration damper buffer interposed between the beam structure member and the vacuum vessel, at least three pillars attached to a base of the bottom superconductor magnet element; and a beam-shaped member for connection member and each pillar.

23. A superconducting magnet apparatus for MRI, comprising:
a single unitary open-air coldmass, the coldmass comprising a rigid metal structure, supporting electromagnetic force with trace deformation,
a superconducting coil group formed of plural superconducting coils, the coldmass further comprising a helium vessel for accommodating the superconducting coil groups and the rigid metal structure, and
a portion for connecting the helium vessel to the rigid metal structure, the coldmass pivotally coupled to a plurality of coldmass suspenders coupled to
a vacuum vessel for accommodating the coldmass and providing vacuum insulation by maintaining an interior under vacuum, and the coldmass suspenders further coupled to a heat shield that is provided in a space between the helium vessel and the vacuum vessel to block off radiation heat to the helium vessel from the vacuum vessel; wherein, the electro-magnetic force load between the superconducting magnet elements bears on only the rigid metal structure within the coldmass and not on the vacuum vessel and only the gravitational force of the coldmass is supported in tension by the coldmass suspenders between the helium vessel and the vacuum vessel.

24. The apparatus of claim 23 wherein a rigid metal structure is a metal structure having load bearing strength of range 50-100 tons without failure.

25. The superconducting magnet apparatus for MRI according to claim 23, wherein:
the cold mass suspenders comprise axial direction supporting members for supporting the coldmass against a force in an axial direction, and radius direction supporting members for supporting the coldmass against forces in a radius direction and in an azimuthal direction.

26. The superconducting magnet apparatus for MRI according to claim 23, further comprising: an antivibration bellows coupled to vacuum sleeve removeably coupled to a cryogen coldhead, whereby access to and maintenance of the coldhead is enabled without substantial loss of cryogen or warming the magnet.

27. The superconducting magnet apparatus for MRI according to claim 23, wherein:
the rigid metal structure comprises a plurality of cylinders for to support each superconducting coil against forces in a radius direction and in an azimuthal direction.

28. A superconductive magnet apparatus for MRI, comprising:
a coldmass, the coldmass comprising a rigid metal structure supportive of electro-magnetic force with trace deformation,
a top superconductive magnet element and
a bottom superconductive magnet element spaced apart from each other with the top superconductive magnet element being on top of the bottom superconductive magnet, each of the top and bottom superconductive magnets elements including a superconducting coil group formed of plural superconductive coils, a plurality of multi-cell concentric cylindrical box girders,
the rigid metal structure having at least three pillars,
the coldmass further comprising
a helium vessel for accommodation of the superconductive coil groups and the rigid metal structure, and
a portion for connecting the helium vessel to the rigid metal structure, the coldmass pivotally coupled to
a plurality of coldmass suspenders coupled to
a vacuum vessel for accommodating the coldmass and providing vacuum insulation by maintaining an interior under vacuum, and the coldmass suspenders further coupled to a heat shield that is provided in a space between the helium vessel and the vacuum vessel to block off radiation heat to the helium vessel from the vacuum vessel;
the vacuum vessel, the heat shield, and the helium vessel each further comprising at least one access port between two pillars of the rigid metal structure, allowing the installation of a pair of gradient coils juxtaposed to opposing inner surfaces between the top superconductive magnet element and the bottom superconductive magnet element to generate a gradient magnetic field, wherein: a homogeneous magnetic field and a gradient magnetic field are generated in a space between the top superconductive magnet element and the bottom superconductive magnet element; wherein, the electro-magnetic force between the superconductive magnet elements is substantially supported only by the rigid metal structure within the coldmass and only the gravitational force of the coldmass is substantially supported in tension by the coldmass suspenders between the helium vessel and the vacuum vessel.

29. The apparatus of claim 28 wherein a rigid metal structure is a metal structure having load bearing strength of range 50-100 tons without plastic deformation.

30. The apparatus of claim 28 wherein the coldmass applies a load of less than 4 tons on its support structure.
